(19) United States
(12) Patent Application Publication
(10) Pub. No.: US 2012/0235317 A1
(43) Pub. Date: Sep. 20, 2012

(54) Manufactured Aggregate Material And Method

(75) Inventor: Jonathan E. Hampton, Bentonville, AR (US)

(73) Assignee: Enviroproducts International LLC

(21) Appl. No.: 13/506,958

(22) Filed: May 29, 2012

Related U.S. Application Data
(63) Continuation of application No. 12/330,882, filed on Dec. 9, 2008.

(51) Int. Cl. C04B 18/18; C04B 18/06; B29C 67/02

(52) U.S. Cl. 264/117; 106/697

(57) ABSTRACT

The present invention provides a manufactured aggregate material that converts waste materials and/or recyclable materials into construction material. By mixing waste materials with an acid solution and a metal oxide solution, any harmful contaminates in the waste materials are encapsulated and rendered into hard pellets that are suitable for use in conglomerates or composites such as concrete. The manufactured aggregate material may be adjusted for moisture content, density, heat capacity, and other parameters.

### CROSS REFERENCE TO RELATED APPLICATION

The present invention claims the benefit of U.S. provisional application Ser. No. 61/012,977, filed Dec. 12, 2007, which is hereby incorporated herein by reference in its entirety.

### FIELD OF THE INVENTION

The present invention relates generally to constituent materials for concrete, and, more particularly, to aggregate materials.

### BACKGROUND OF THE INVENTION

Concrete is typically made up of aggregate or filler materials, such as sand, gravel, or the like, and a binder or binding agent, such as portland cement. The aggregate and the binder are mixed together in a desirable proportion, and water is added to initiate a chemical reaction in the binder that hardens the mixture into finished concrete. Aggregates have additional applications, such as in place of sand and/or gravel, as a growing media for plants, water filtration, artificial stones (e.g. for landscaping), substrate materials for bio-roofs, and refractory products, for example.

### SUMMARY OF THE INVENTION

The present invention provides a manufactured aggregate material that is made up of waste materials and/or recyclable materials. Embodiments of the present invention permit the production of finished conglomerates or composites such as concrete. The manufactured aggregate material may be approximately one-half the density of conventional aggregate materials. Additionally, embodiments of the present invention provide a method of converting waste materials, some of which may be environmentally hazardous or undesirable, into saleable building materials.

According to one aspect of the invention, a method is provided for preparing aggregate material for use in composite or conglomerate materials such as concrete, or anywhere a stable filler may be used. The method includes providing a waste material, mixing the waste material with an acid such as phosphoric acid, and further mixing with a metal oxide such as magnesium oxide, caustic calcined magnesium oxide, or such other compounds having similar properties. The ratio of metal oxide to may be approximately 1:1, while the ratio of waste material to the combination of magnesium oxide and phosphoric acid may be approximately 14:1. The recycled or waste material may be made of bottom ash, non-saleable fly ash, paper, glass, rice hulls, crushed concrete, polymers, petrochemicals, sawdust, wood chips, municipal solid waste (MSW) incinerator ash, medium density fiberboard (MDF) dust, soil, other materials having similar properties, or combinations thereof.

According to another aspect of the invention, a method is provided for preparing aggregate material for use in concrete, where the method includes providing at least one hopper for containing a waste material, dispensing the waste material into a first mixer, dispensing phosphoric acid into the first mixer, and mixing the waste material and phosphoric acid in the first mixer to obtain a first product. Next, the first product is dispensed into a second mixer, after which magnesium oxide is dispensed into the second mixer, whereupon the first product and the magnesium oxide are mixed in the second mixer to obtain a second product. Finally, the second product is dispensed into an agglomerator where it is pelletized, resulting in a pelletized manufactured aggregate material.

These and other objects, advantages, purposes, and features of the present invention will become apparent upon review of the specification in conjunction with the drawings.

### BRIEF DESCRIPTION OF THE DRAWINGS

FIG. 1 is a top plan view of a manufactured aggregate material facility in accordance with the present invention; and

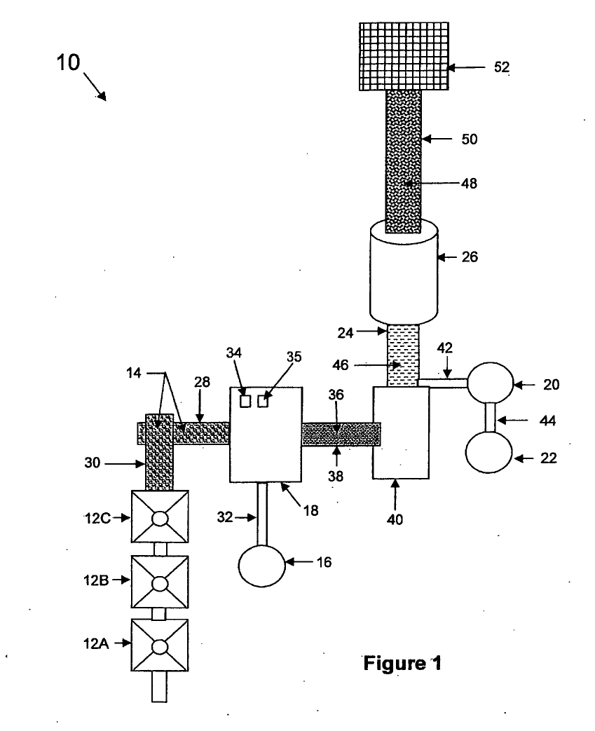

FIG. 2 is a flow chart illustrating a reaction process in accordance with the present invention.

### DESCRIPTION OF THE PREFERRED EMBODIMENTS

Referring now specifically to the drawings and the illustrative embodiments depicted therein, an aggregate material manufacturing facility 10 includes a plurality of hoppers 12a, 12b, 12c for storing recycled or waste materials 14, an acid tank 16, a first mixer 18, a metal oxide solution tank 20, an optional dry metal oxide tank 22, a mixing auger 24, and an agglomerator 26.

Hoppers 12a, 12b, 12c contain recycled or waste materials 14 for processing at aggregate material manufacturing facility 10. Hopper 12a may contain a wholly different material than hopper 12b, which may contain a wholly different material from hopper 12c, for example. Alternatively, hoppers 12a, 12b, 12c may contain different batches of similar materials, such as bottom ash produced from different grades of coal. If dry bottom ash or dry unsaleable fly ash is to be used, water may be added to achieve about 5% to 10% moisture by weight to improve handling of the ash. If waste materials or recycled materials are used that are not naturally in granular or small-particle form, a granulating or shredding or grinding step may be performed on the material to reduce its particle size.

A first conveyor 28 transports waste materials 14 between hoppers 12a, 12b, 12c and first mixer 18. A weigh belt 30 may be provided for measuring the weight of waste materials 14 as they are dispensed from hoppers 12a, 12b, 12c. Acid tank 16 contains and dispenses a liquid acid solution into first mixer 18 via a pipe 32. First mixer 18 includes a moisture sensor 34 for measuring the moisture content of waste materials 14 that are contained in first mixer 18. Moisture sensor 34 may be a contact sensor, an infrared or non-contact sensor, or the like. In addition, a temperature sensor 35 may be included at first mixer 18 for measuring the temperature of incoming waste materials 14. First mixer 18 may be shrouded and vented to contain and safely vent sulfuric acid and other undesired chemicals. First mixer 18 mixes waste materials 14 and a metered amount of acid to form a first mixture or product 36 in a chemical reaction, as will be described in greater detail below. A computer or processor (not shown) receives weight data from weigh belt 30, moisture data from sensor 34, and temperature data from temperature sensor 35 to determine the appropriate amount of acid, water, and heat to add to waste materials 14 in first mixer 18.

A second conveyor 38 transports the first product 36 to a holding hopper 40 that collects and dispenses first product 36 into mixing auger 24. Hopper 40 may include an agitator, such as an air-pulse agitator or a mechanical agitator, to maintain the handling qualities of first product 36 by preventing bridging or caking of first product 36. Mixing auger 24 is preferably a high-shear mixer. Suitable mixers for mixing auger 24 include, for example, volumetric mixers, turbine mixers, double-helix mixers, and the like, such as are available from Mixer Systems, Inc. of Pewaukee, Wis., from Cementech, Inc. of Indianola, Iowa, and/or from Inventure Systems Ltd. of Ontario, Canada. Although described as an auger, it will be appreciated that mixing auger 24 represents any suitable high-shear mixing device or apparatus.

Metal oxide solution tank 20 contains and dispenses a liquid metal oxide solution or slurry via a pipe 42, and includes an agitator (not shown) for maintaining even distribution of the metal oxide in solution and/or for preventing metal oxide from settling or precipitating out of solution while contained in tank 20. Optional dry metal oxide tank 22 stores metal oxide in dry form and dispenses the dry metal oxide into metal oxide solution tank 20 via a pipe 44, where it is mixed with water to form the liquid metal oxide solution or slurry.

Mixing auger 24 mixes the first product 36 from holding hopper 40 with liquid metal oxide solution from tank 20 to form a second mixture or product 46 in a chemical reaction that will be described in greater detail below. Mixing auger 24 dispenses second product 46 into agglomerator 26. Agglomerator 26 converts second product 46 into aggregate granules or pellets 48 by agitation and/or collision, preferably without compression. Such an agglomerator is available, for example, from FEECO International, Inc. of Green Bay, Wis. or Mars Mineral Corp. of Mars, Pa.

Agglomerator 26 may be positioned at an incline to control the approximate size of pellets 48 as they exit agglomerator 26. Agglomerator 26 produces smaller pellets when it is positioned at a relatively steep incline, such as about 10° to 20° from horizontal, and produces larger pellets when positioned at a relatively shallow incline, such as about 0° to 10° from horizontal. Other factors that may affect the size of pellets 48 include, for example, the type of agglomerator used, the moisture content of second product 46, and speed of the agglomerator.

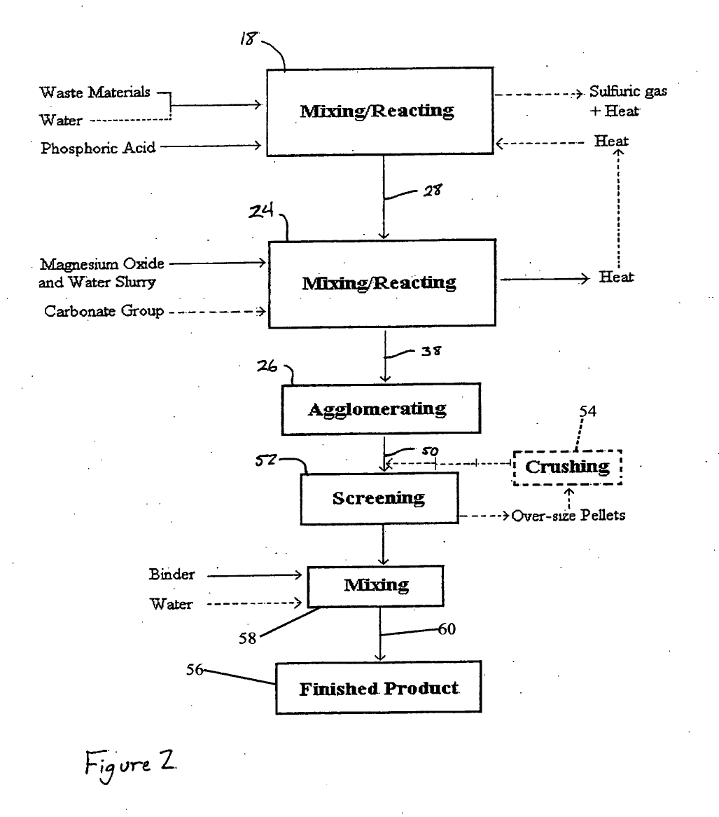

A third conveyor 50 transports pellets 48 from agglomerator 26 to a screen device 52. Screen device 52 filters out over-sized particles for crushing 54 (FIG. 2) and replacement on third conveyor 50 for re-filtering, whereas sufficiently small pellets pass through screen 52 and are collected for use. Optionally, a plurality of screen devices having progressively larger openings or pores may be arranged in series to sort pellets 48 according to size.

Waste materials 14 typically include impurities or contaminates such as heavy metals (e.g. arsenic, selenium, cadmium), sulfur and the like, and may contain any range of moisture, from nearly zero moisture up to about 30% moisture content. Suitable materials for waste material 14 include, for example, paper, polymers, petrochemicals, rice hulls, crushed concrete, bottom ash and non-saleable fly ash left over from the burning of coal, and other waste materials including sawdust, wood chips, ash from the incineration of municipal solid waste (MSW), medium density fiberboard (MDF) dust, and soil. If waste materials 14 contain more than about 30% moisture by weight, it may be desirable to perform a drying process to lower the moisture to 30% or less. Alternatively, if waste materials 14 contain little or no moisture, it may be desirable to add water to raise the moisture level to at least about 10% to 15% by weight.

Waste materials 14 are mixed with acid, such as phosphoric acid solution (H₃PO₄) at about 5% concentration, in first mixer 18 at a minimum ratio of about twenty parts waste materials 14 to one part phosphoric acid, by weight. Other suitable acids may also be used, such as oxalic acid (H₂C₂O₄) or other acids having a pH of between about zero and four. Waste materials 14 and phosphoric acid are mixed sufficiently, such as for up to about ten minutes, to ensure wetting of substantially all particles of waste material 14. During mixing, the phosphoric acid reacts with the aforementioned impurities in waste materials 14 to transform them into less hazardous chemicals, including chemicals that may have additional binding properties. Impurities in waste materials 14 and phosphoric acid react exothermically and typically cause a temperature rise of about 10-20° Fahrenheit. In order to facilitate faster chemical reactions in first mixer 18, it is preferable that the starting temperature of waste materials 14 is at least about 80° Fahrenheit. Waste materials 14 may be heated in first mixer 18, or heated before reaching first mixer 18, such as by using heat produced in mixer auger 24, as will be described in greater detail below.

Water may be added to waste materials in first mixer 18 to account for lower moisture levels in waste materials 14, as detected by moisture sensor 34 and weigh belt 30, to achieve about 10% to 15% moisture overall, ensuring that substantially all particles leaving first mixer 18 are wetted. In addition to the above reactants and product, any sulfur present in waste materials 14 (such as in ash from the burning of coal) is liberated from waste materials 14 and reacts with hydrogen and oxygen to form sulfuric gas (H₂SO₄), which may be trapped by shrouds and vented from first mixer 18 by fans. Additionally, the sulfuric gas may be passed through a heat exchanger to store heat from the gas for other uses.

The temperature of the first product 36 in first mixer 18 is monitored by temperature sensor 35 to determine when the reaction is complete or nearly complete. When the temperature, which initially rises about 10° to 20°, has leveled off or begun to drop, the reaction is substantially complete and first product 36 is moved to hopper 40 via second conveyor 38.

First product 36 is stored in hopper 40 and transferred to mixing auger 24 in batches or in a continuous process. Metal oxide solution, preferably magnesium oxide (MgO) mixed with water to form a wet slurry, is dispensed from solution tank 20 into mixer auger 24, where a reaction begins between the magnesium oxide and phosphoric acid to form magnesium oxyphosphate (i.e. magnesium phosphate).

The presence of moisture in first product 36 and in the metal oxide solution is desirable to accelerate the reaction taking place between the acid and the metal oxide in mixing auger 24. The reactants of first product 36, including phosphoric acid and magnesium oxide solution, for example, form magnesium oxyphosphate as a binder in combination with the unreacted portions of waste materials 14, which form second product 46 having gel-like properties. This exothermic reaction typically causes a temperature rise of about 40° to 50° Fahrenheit to a resultant temperature of about 160° Fahrenheit or higher, depending on the starting temperatures of first product 36 and metal oxide slurry. The heat produced in mixing auger 24 may be withdrawn by a heat exchanger and transferred to another stage of the process, such as at first mixer 18, to increase the speed of the reaction therein.

Second product 46, in gel form, is passed to agglomerator 26 where it is rolled and/or agitated to pelletize second product 46 into hard pellets 48. Agglomerator 26 dispenses the pellets 48 onto third conveyor 44, where the pellets 48 are transported to screening device 52 for sorting as described above.

Manufactured aggregate pellets 48 typically harden further over a period of two to three days and lose moisture content. Optionally, the aggregate pellets 48 may be soaked, coated, saturated, or sprayed with sodium silicate, potassium silicate, or the like to form aggregate having less than about 5% moisture content by weight.

The final density of the aggregate pellets 48 may be adjusted by the addition of a carbonate group, such as calcium carbonate, potassium carbonate, sodium carbonate, or the like at the high-shear mixing stage of manufacturing, such as through a port in mixing auger 24, to form pockets of carbon dioxide within pellets 48. With the addition of a carbonate group, the carbonate reacts with phosphoric acid to create carbon dioxide bubbles. The density of pellets 48, and thus the finished products made from pellets 48, also varies by the type of ash or other waste material that is used, and the finished products may incorporate about 90% waste materials by weight. Thus, by selecting and/or blending the type of materials fed into first mixer 18, an operator may control the density and other properties of pellets 48 and finished products made therefrom. The density of the manufactured aggregate pellets 48 may, for example, be about one-half that of conventional aggregates.

The resultant manufactured aggregate material may be blended with a binder, such as portland cement or mineral-based binders such as RenuAgg™, RenuStone™, or RenuBinder™ family of mineral-based binders, which is available, for example, from EnviroProducts International LLC of Longmont, Colo. Typically, the manufactured aggregate material may be blended or mixed with binder in the same ratios as natural aggregates or other manufactured aggregates to form a premix. Alternatively, the manufactured aggregate material may be used in place of gravel, sand, or in other applications where chemically stable filler or aggregate material is desired.

Thus, harmful or otherwise-valueless waste materials 14 are ameliorated into useful building materials 56, which may be mixed 58 with binder and water and formed 60 (FIG. 2) in any conventional manner, such as by pouring, casting, molding, extruding, or similar processes. Heavy metals, such as arsenic, selenium, cadmium, and the like, which would otherwise leach out of uncontained bottom ash or unsaleable fly ash from coal burning, for example, are encapsulated in building materials and stably isolated from the environment. Additionally, because of their recycled content, concrete products made with manufactured aggregate material pellets 48 typically qualify for points towards certification under the Leadership in Energy and Environmental Design (LEED), a benchmark for the design, construction, and operation of high-performance “green” or environmentally-friendly buildings.

Optionally, manufactured aggregate pellets 48 may incorporate one or more phase-change materials to alter the heat capacity of the aggregate and products made therefrom. Phase-change materials (PCMs) include organic compounds such as waxes that store heat and release it slowly into the surrounding environment. By incorporating PCMs into manufactured aggregate pellets, buildings or other structures used in construction can more effectively manage heat, such as for maintaining comfortable room temperatures, for example.

PCMs may be incorporated into manufactured aggregate pellets for use in building energy-efficient structures. For example, wax-type PCMs are typically dry and may be added at any stage of the process described hereinabove. Liquid-type PCMs may be added to first mixer 18, so long as the moisture in the liquid PCM is taken into account in the total water or moisture content of the mixer's contents. Additional detail on PCMs and their use is available in the document enclosed herewith, entitled “Heat Storage Compositions And Their Manufacture,” which is hereby incorporated herein by reference in its entirety.

Changes and modifications in the specifically described embodiments may be carried out without departing from the principles of the present invention, which is intended to be limited only by the scope of the appended claims, as interpreted according to the principles of patent law including the doctrine of equivalents.

1. A method of preparing aggregate material, said method comprising:
providing a waste material in granular form;
first mixing a waste material having a moisture content less than 30% with a phosphoric acid solution so that the waste material is thoroughly wetted to obtain an exothermic reaction for a period ranging from 0.5 to 10 minutes to obtain a first resultant product;
mixing a metal oxide premixed with water to form a slurry to said first resultant product to obtain a second resultant product; and
forming the second resultant product into pellets to obtain an aggregate material.

2. The method according to claim 1, wherein the weight ratio of metal oxide to phosphoric acid solution in the second resultant product is approximately 1:1.

3. The method according to claim 1, wherein the waste material comprises at least one of a group consisting of: bottom ash, unsaleable fly ash, paper, glass, rice hulls, crushed concrete, polymers, petrochemicals, sawdust, wood chips, MSW incinerator ash, MDF dust, and soil.

4. The method according to claim 1, wherein said phosphoric acid solution is about 5% in concentration.

5. The method according to claim 1, where said metal oxide is magnesium oxide.

6. The method according to claim 1, wherein the waste material is bottom ash and the metal oxide is magnesium oxide with the weight ratio of bottom ash to the magnesium oxide being about 14:1.

7. The method according to claim 1, further comprising mixing the pelletized aggregate material with a binder to form a concrete.

8. The method according to claim 7, further comprising forming a concrete product with the concrete.

9. A method of preparing aggregate material, said method comprising:
providing a supply of bottom ash;
heating said bottom ash to a temperature of at least about 80° F.;
dispensing the bottom ash into a first mixer;
dispensing phosphoric acid into the first mixer;
mixing the bottom ash and the phosphoric acid in the first mixer to obtain a acid treated product;
dispensing the acid treated first product into a second mixer;
dispensing magnesium oxide into the second mixer;
mixing the acid treated product and the magnesium oxide in the second mixer to obtain a second product resulting from the reaction of magnesium oxide with the acid treated product;
dispensing the second product into an agglomerator; and
pelletizing the second product in the agglomerator to obtain pelletized aggregate material.

10. (canceled)

11. (canceled)

12. (canceled)

13. (canceled)

14. The method according to claim 9, further comprising the steps of:
dispensing the pelletized aggregate material onto a screen; and
sorting the pelletized aggregate material by size at the screen.

15. (canceled)

16. (canceled)

17. The method according to claim 9, wherein the weight ratio of magnesium oxide to phosphoric acid in the second resultant product is approximately 1:1.

18. (canceled)

19. The method according to claim 9, wherein the weight ratio of bottom ash to the combined weight of magnesium oxide and phosphoric acid is approximately 14:1.

20. (canceled)

21. (canceled)

22. (canceled)

23. (canceled)

24. (canceled)

25. The method according to claim 1, wherein the mixing of the waste material with the acid solution is performed for a time period of less than about ten minutes.

26. A method of preparing aggregate material, said method comprising:
providing a waste material in granular form;
mixing the waste material with an acid for less than about ten minutes to obtain an initial resultant product in which the waste material is fully wetted with the acid causing a raise in temperature;
adding a metal oxide to the initial resultant product when the temperature of said initial resultant product levels off or begins to drop and mixing the metal oxide in the initial resultant product to obtain a second resultant product having a weight ratio of the waste material to the combination of metal oxide and acid of about 14:1; and
then pelletizing the second resultant product to obtain the aggregate material.

27. The method according to claim 26, wherein said method includes the additional steps of screening the aggregate material to size the aggregate; and drying the sized aggregate so that it has a moisture content less than 5%.

28. A method according to claim 26 wherein said acid is a phosphoric acid of a 5% concentration.

29. A method according to claim 26 wherein said waste material is preheated to at least 80° F. before mixing with said phosphoric acid solution.

30. A method according to claim 28 wherein said first resulting product of waste material mixed with phosphoric acid solution produces an exothermic reaction causing a temperature rise to at least about 160° F.

31. A method according to claim 1 including an additional step of adjusting the final density of the second resultant product pellets by adding a carbonate group to the metal oxide water slurry.
